(19) United States
(12) Patent Application Publication
(10) Pub. No.: US 2024/0272532 A1
(43) Pub. Date: Aug. 15, 2024

(54) LIGHT SOURCE DEVICE AND PROJECTOR APPARATUS

(71) Applicant: Momotaro YOSHIDA, Kanagawa (JP)

(72) Inventor: Momotaro YOSHIDA, Kanagawa (JP)

(21) Appl. No.: 18/416,931

(22) Filed: Jan. 19, 2024

(30) Foreign Application Priority Data
Feb. 9, 2023 (JP) 2023-018631

(51) Int. Cl. G03B 21/16; G03B 21/14; G03B 21/20

(52) U.S. Cl. CPC G03B 21/16; G03B 21/145; G03B 21/2033; G03B 21/206

(57) ABSTRACT

A light source device includes: a laser light source to emit a laser light beam having a wavelength; multiple wavelength converters to convert the wavelength of the laser light beam emitted from the laser light source to other wavelengths different from the wavelength to emit other light beams having the other wavelengths; an airflow generator to generate at least one airflow; and a blower to blow said at least one airflow to each of the multiple wavelength converters based on a predetermined blowing condition.

### CROSS-REFERENCE TO RELATED APPLICATION

This patent application is based on and claims priority pursuant to 35 U.S.C. § 119(a) to Japanese Patent Application No. 2023-018631, filed on Feb. 9, 2023, in the Japan Patent Office, the entire disclosure of which is hereby incorporated by reference herein.

### BACKGROUND

### Technical Field

Embodiments of this disclosure relate to a light source device and a projector apparatus.

### Related Art

A light source unit such as a projector light source using a laser light source and a phosphor wheel (serving as a wavelength converter) has been developed. For example, in order to maintain the luminous efficiency of a phosphor wheel in an optimal state, a light source technology includes a cooling device that cools multiple phosphor wheels by controlling the rotation of the multiple phosphor wheels or by at least one or more fans.

In the projector light source described above, a single fan (serving as an airflow generator) cools the multiple phosphor wheels. If multiple cooling devices corresponding to the phosphor wheels are disposed, the size of the projector light source may increase and the number of components may increase.

### SUMMARY

According to an embodiment of the present disclosure, a light source device includes: a laser light source to emit a laser light beam having a wavelength; multiple wavelength converters to convert the wavelength of the laser light beam emitted from the laser light source to other wavelengths different from the wavelength to emit other light beams having the other wavelengths; an airflow generator to generate at least one airflow; and a blower to blow said at least one airflow to each of the multiple wavelength converters based on a predetermined blowing condition.

According to an embodiment of the present disclosure, a projector apparatus includes: a projection optical system to project an image formed by an image forming element with the light beam from the light source device.

### BRIEF DESCRIPTION OF THE DRAWINGS

A more complete appreciation of the disclosure and many of the attendant advantages and features thereof can be readily obtained and understood from the following detailed description with reference to the accompanying drawings, wherein:

FIG. 1 is a schematic diagram illustrating a configuration of a projector apparatus serving as a display apparatus according to an embodiment of the present disclosure;

FIG. 2A is a diagram illustrating a configuration of a light source device of a projector apparatus according to an embodiment of the present disclosure;

FIG. 2B is a diagram illustrating a configuration of a light source device of a projector apparatus according to an embodiment the present disclosure;

FIG. 3A is a diagram illustrating a configuration of a light source device according to an embodiment of the present disclosure;

FIG. 3B is a diagram illustrating a specific configuration of a projector light source unit according to an embodiment of the present disclosure;

FIG. 4A is a diagram illustrating a specific configuration of a projector light source unit according to an embodiment of the present disclosure;

FIG. 4B is a diagram illustrating a configuration of an airflow generator and a duct structure in the case where light source modules of a light source device according to an embodiment of the present disclosure are arranged at an right-angle relation;

FIG. 5 is a diagram illustrating a control block of a light source device according to an embodiment of the present disclosure;

FIG. 6 is a diagram illustrating a hardware configuration of a controller of the light source device of FIG. 5, according to an embodiment of the present disclosure;

FIG. 7 is a bottom view of a heat dissipation part of a light source device according to an embodiment of the present disclosure;

FIG. 8 is a perspective bottom view of the heat dissipation part of the light source device illustrated in FIG. 7;

FIG. 9 is a flowchart of a control process of a blowing condition by a light source device according to an embodiment of the present disclosure;

FIG. 10 is a diagram illustrating a duct structure of a light source device according to an embodiment of the present disclosure;

FIG. 11 is a diagram illustrating a functional configuration of a controller of a light source device according to an embodiment of the present disclosure; and

FIG. 12 is a flowchart of a process of changing the airflow volume or blowing condition depending on a projection mode in a light source device according to one embodiment of the present disclosure.

The accompanying drawings are intended to depict embodiments of the present invention and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

According to an embodiment of the present disclosure, a light source device can achieve the cooling optimized for temperature states of the multiple wavelength converters while preventing the size of the light source device from increasing.

A light source device and a projector apparatus according to embodiments of the present disclosure will be described in detail below with reference to the accompanying drawings.

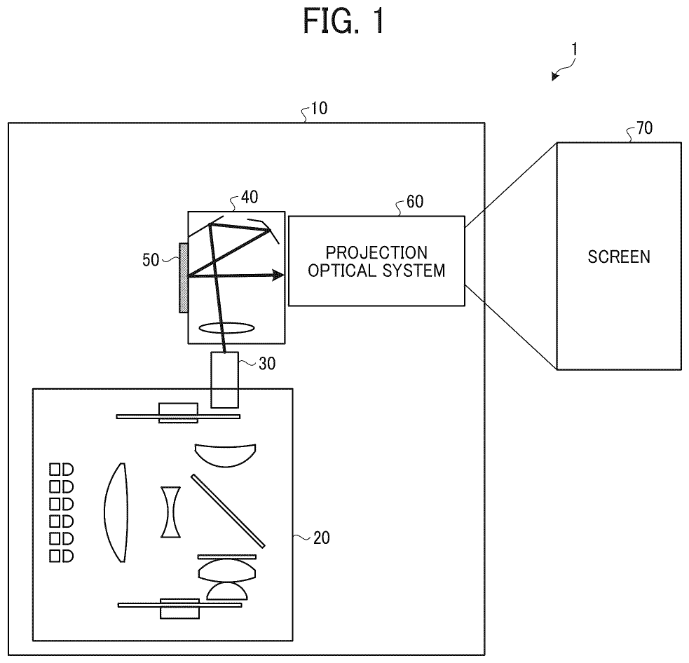

FIG. 1 is a schematic diagram illustrating a configuration of a projector apparatus 1 serving as a display apparatus according to an embodiment of the present disclosure. The projector apparatus 1 according to an embodiment of the present disclosure serves as a display apparatus such as a projector, and includes a housing 10, a light source device 20, a light homogenizer 30, an illumination optical system 40, an image forming element 50 (image display element), and a projection optical system 60.

The housing 10 accommodates the light source device 20, the light homogenizer 30, the illumination optical system 40, the image forming element 50, and the projection optical system 60.

In some embodiments, a projector apparatus includes: a projection optical system to project an image formed by an image forming element with the light beam from the light source device.

The light source device 20 emits light beams including a laser light beam, and the light beams have wavelengths corresponding to colors of, for example, red, green, and blue (RGB). The inner configuration of the light source device 20 is described later in detail.

The light homogenizer 30 mixes the light beams emitted from the light source device 20 to homogenize the light intensities of the light beams including the laser light beam. As the light homogenizer 30, for example, a light tunnel in which four mirrors are combined, a rod integrator, or a fly-eye lens is used.

The illumination optical system 40 substantially uniformly illuminates the image forming element 50 with an illumination light beam homogenized by the light homogenizer 30. The illumination optical system 40 includes, for example, one or more lenses or one or more reflection surfaces.

The image forming element 50 is a light valve (spatial light modulator) such as a digital micromirror device (DMD), a transmissive liquid crystal panel, or a reflective liquid crystal panel. The image forming element 50 modulates the illumination light beam (i.e., the illumination light beam including the laser light beam emitted from a light source optical system in the light source device 20) with which the illumination optical system 40 illuminates the image forming element 50 to form an image. In other words, the image forming element 50 turns on and off a light beam of each pixel forming the image formed by the light source device 20, and serves as a spatial light modulator to form an image.

The projection optical system 60 magnifies and projects the image formed by the image forming element 50 to a screen 70 (projection surface). The projection optical system 60 includes, for example, one or more lenses.

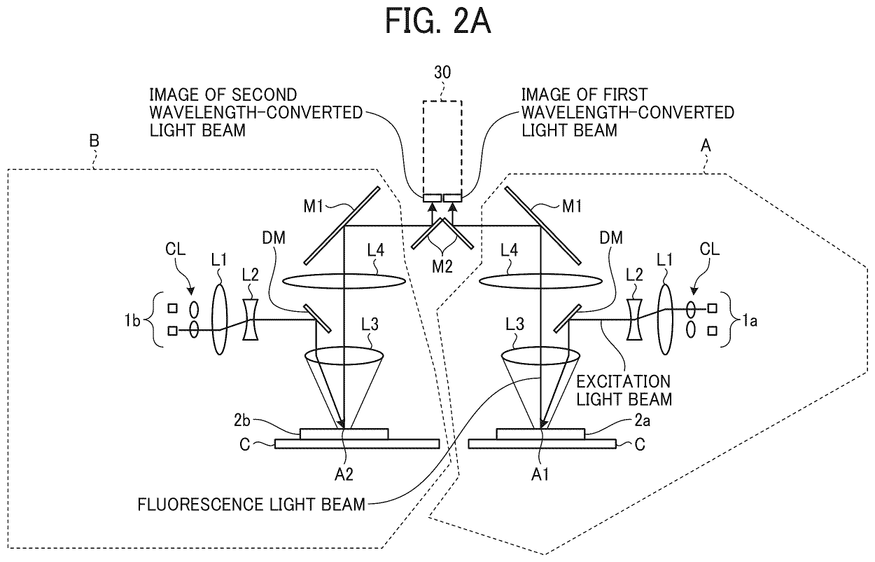

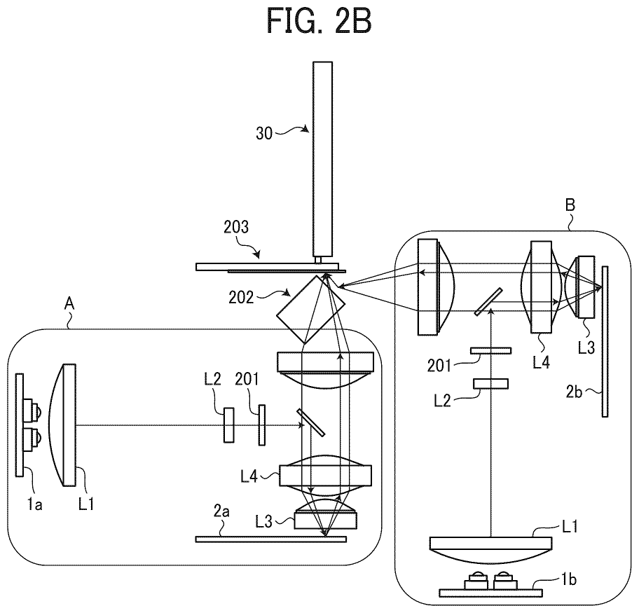

FIG. 2A is a diagram illustrating a configuration of a light source device of the projector apparatus according to an embodiment of the present disclosure. The light source device 20 (serving as a light source unit) according to an embodiment of the present disclosure includes a wavelength-conversion light source A and a wavelength-conversion light source B. In the following description, the configuration of the wavelength-conversion light source A will be described, but the wavelength-conversion light source B has the same configuration.

The wavelength-conversion light source A includes a laser light source 1a including 2×4 semiconductor lasers. A laser light beam (ray or light source beam) emitted from the laser light source 1a is condensed on a collimator lens CL and guided to a dichroic mirror DM by an optical system including light condensing elements L1 and L2. The light source beam guided to the dichroic mirror DM is reflected by the dichroic mirror DM. A first wavelength conversion region A1 of a wavelength converter 2a (e.g., phosphor) formed on a substrate C is irradiated with the light source beam.

The light source beam reaches the wavelength conversion region (i.e., first wavelength conversion region A1) of the wavelength converter 2a. An image of the first wavelength conversion region A1 is formed at a conjugate position having an imaging relation by the optical elements L3 and L4, and the mirrors M1 and M2. The conjugate position is a position at which an image formed by a wavelength-converted light beam (i.e., image formed by a light beam whose wavelength is converted by the first wavelength conversion region A1) in the first wavelength conversion region A1 illustrated in FIG. 2A is formed. The wavelength-converted light beam is a light beam whose wavelength is converted by the first wavelength conversion region A1 of the wavelength converter 2a.

On the other hand, a second wavelength conversion region A2 of a wavelength converter 2b (e.g., phosphor), which is different from the first wavelength conversion region A1 of the wavelength converter 2a, is irradiated with the light source beam from the laser light source 1b. An image of a wavelength-converted light beam (i.e., image formed by the second wavelength-converted light beam) having the relation of the conjugate position with the second wavelength conversion region A2 is formed at a position adjacent to or superimposed on the image of the first wavelength-converted light beam by the optical elements L3 and L4, and the mirrors M1 and M2.

Thus, the image of the first wavelength-converted light beam and the image of the second wavelength-converted light beam form a single combined image. The single combined image is formed at a light incident opening of the light homogenizer 30 indicated by a broken line in FIG. 2A. Then, the single combined image is reflected and homogenized in the light homogenizer 30.

The laser light sources 1a and 1b emit, for example, a blue light beam or an ultraviolet light beam as an excitation light beam to excite the wavelength converters 2a and 2b. Specifically, the laser light sources 1a and 1b serve as multiple excitation light sources. In the multiple excitation light sources, the laser light source 1a irradiates the first wavelength conversion region A1 with an excitation light beam, and the laser light source 1b irradiates the second wavelength conversion region A2 with an excitation light beam at the same timing. In an embodiment of the present disclosure, each of the laser light sources 1a and 1b may include one laser diode (LD) or an LD array in which the LDs are arranged in multiple rows so that the shape of the LD array is rectangular. In an embodiment of the present disclosure, each of the laser light sources 1a and 1b uses an LD array having 8 LDs of 2×4, but may use a multi-chip type. In an embodiment of the present disclosure, the light source in the laser light source 1a is the same with the light source in the laser light source 1b. However, the laser light source 1a and the laser light source 1b may share an LD array of 4×4 by dividing the LD array by a mirror or a half-mirror as two light sources.

In an embodiment of the present disclosure, the first wavelength conversion region A1 of the wavelength converter 2a is formed on a substrate C, and the second wavelength conversion region A2 of the wavelength conversion converter 2b is formed on another substrate C different from the substrate C. However, the configuration of the substrates is not limited to the configuration described above. The first wavelength conversion region A1 and the second wavelength conversion region A2 may be formed on one substrate C. Preferably, the substrate C has a disk-shape and a thermal conductivity higher than a thermal conductivity of the phosphor. For example, the substrate is made of ceramics or metal, and the substrate is coated with the phosphor, or the phosphor is fixed to the substrate with glue. Alternatively, the substrate C may have a disk-shape and rotates around its center as a rotation axis. The phosphor regions (e.g., wavelength converters 2a and 2b) are formed around the circumferential direction of the substrate. As the substrate rotates, the phosphor regions also rotates. In other words, the substrate C may serve as a phosphor wheel.

FIG. 2B is a diagram illustrating another configuration of the light source device of the projector apparatus according to an embodiment of the present disclosure. The light source device 20 according to an embodiment of the present disclosure includes two light source modules (i.e., wavelength-conversion light source A and wavelength-conversion light source B) arranged in a right-angle relation. In other words, the longitudinal directions of the wavelength-conversion light sources A and B are perpendicular to each other. In each of the two light source modules, some lenses (e.g., a fly-eye lens 201), a dichroic mirror, a phosphor (i.e., the wavelength converters 2a and 2b), a prism 202, a color wheel, and a light tunnel (i.e., the light homogenizer 30) are arranged so that excitation light beams (laser light beams) emitted from the laser light sources 1a and 1b are directed to the light tunnel. The two light source modules are disposed so that the longitudinal directions of the light source modules are substantially perpendicular to each other or the light emitting directions are substantially perpendicular to each other. In FIG. 2B, the two light source modules have the same internal structure, but may have different internal structures.

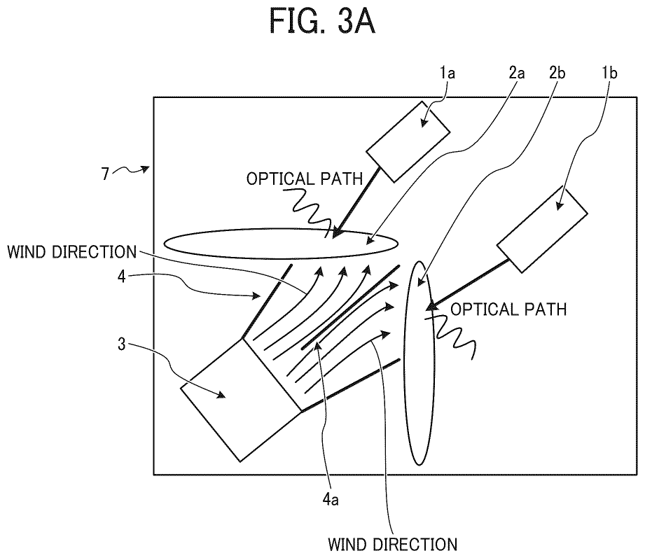

FIG. 3A is a diagram illustrating a configuration of a light source device according to an embodiment of the present disclosure. The light source device 20 according to an embodiment of the present disclosure serves as an projector optical unit. Specifically, as illustrated in FIG. 3A, the light source device 20 serves as a light source unit including the laser light sources 1a and 1b, the wavelength converters 2a and 2b, an airflow generator 3, a duct structure 4, and a light source container 7. The light source device 20 according to an embodiment of the present disclosure can apply to a display apparatus such as a projector having a projection optical system 60. In the projector, an image forming element 50 (serving as an image forming device) is irradiated with the light beam emitted from the light source device 20 to form an image, and the image formed by the image forming element 50 is projected by the projection optical system.

The light source container 7 accommodates the laser light sources 1a and 1b, the wavelength converters 2a and 2b, the airflow generator 3, and the duct structure 4. The laser light sources 1a and 1b serve as laser light sources that emit laser light beams (i.e., excitation light beams) to irradiate an object with the laser light beams.

The wavelength converter 2a serves as a wavelength conversion unit that emits a light beam having a wavelength different from the wavelength of the laser light beam emitted from the laser light source 1a or reflects the laser light beam emitted from the laser light source 1a. The wavelength converter 2b serves as a wavelength conversion unit that emits a light beam having a wavelength different from the wavelength of the laser light beam emitted from the laser light source 1b or reflects the laser light beam emitted from the laser light source 1b. In an embodiment of the present disclosure, the light source device 20 includes two wavelength converters 2a and 2b. However, the light source device 20 may include at least two wavelength converters. Alternatively, the light source device 20 may include three or more wavelength converters.

The airflow generator 3 serves as an airflow generation device such as a sirocco fan that generates airflow in the light source container 7. The duct structure 4 has a duct structure that guides the airflow generated from the airflow generator 3 to the wavelength converters 2a and 2b. At this time, the direction of the airflow generated from the airflow generator 3 is not limited to a specific direction. For example, the direction of the airflow generated from the airflow generator 3 may be the intake direction or the exhaust direction with respect to the wavelength converters 2a and 2b. The duct structure 4 includes a structural part 6 (e.g., partition plate) that divides the airflow generated from the airflow generator 3 into multiple portions in at least two directions. In other words, the structural part 6 serves as a blower that divides the airflow (divided airflow) generated from the airflow generator 3 based on a predetermined blowing condition (i.e., blowing condition determined in advance) with respect to each of the wavelength converters 2a and 2b, and blows the divided airflow to the wavelength converters 2a and 2b. As a result, the wavelength converters 2a and 2b can be cooled. The blowing condition is a condition of the airflow to be blown to the wavelength converters 2a and 2b. For example, the blowing condition includes an airflow volume to be blown from the airflow generator 3 to the wavelength converters 2a and 2b (multiple wavelength converters) determined by information or a structure. In the case of the information, the information includes a ratio of an airflow volume to be blown to each wavelength converter to the total airflow or a ratio of the wind velocity of the airflow. In other words, the information is the setting information to set the airflow volume to be blown to the each wavelength converters. In the case of the structure, the structure includes the width or the difference of the area of the cross-section of the duct structure 4. Further, both the airflow volume and the wind velocity may be assigned to the blowing condition. The airflow condition may be determined depending on each size of the wavelength converters 2a and 2b or the difference between the laser output to the wavelength converter 2a and the laser output to the wavelength converter 2b. In the case where the size of the wavelength converter 2a and the size of the wavelength of the wavelength converter 2b are the same or the output of the laser light source 1a and the output of the laser light source 1b are the same, the airflow volume be blown to the wavelength converter 2a and the airflow volume to be blown to the wavelength converter 2b are one to one (1:1). In the case where the size of the wavelength converter 2a and the size of the wavelength converter 2b are different from each other, the airflow volume to be blown to each wavelength converter may be changed by changing the blowing condition depending on the ratio of area or mass between the wavelength converters 2a and 2b. In addition, the airflow volume may be changed using various information relating to the wavelength converters 2a and 2b as the blowing condition. For example, the information includes a ratio between the laser outputs (current values and irradiation amounts) to the wavelength converters 2a and 2b, temperature information (temperature difference and ratio) of each wavelength converter detected by the temperature sensor of each wavelength converter, and the difference in the distance and positional relation from the airflow generator 3 to each wavelength converter. In changing the blowing condition, the airflow volume may be occasionally changed when the information on the wavelength converter 2a and the wavelength converter 2b is changed (e.g., as the detected temperature has changed, the temperature of one wavelength converter has turned to be higher). As a result, in the light source device 20 including the wavelength converter 2a and the wavelength converter 2b, the cooling that is optimized for the thermal states of the wavelength converter 2a and the wavelength converter 2b can be performed while preventing the size of the light source device 20 from increasing.

In some embodiments, a light source device includes: a laser light source to emit a laser light beam having a wavelength; multiple wavelength converters to convert the wavelength of the laser light beam emitted from the laser light source to other wavelengths different from the wavelength to emit other light beams having the other wavelengths; an airflow generator to generate at least one airflow; and a blower to blow said at least one airflow to each of the multiple wavelength converters based on a predetermined blowing condition.

In some embodiments, the light source device further includes circuitry to set the predetermined blowing condition for each of the multiple wavelength converters according to at least one of: setting information of an airflow volume of said at least one airflow; or a structure of the blower.

In some embodiments, in the light source device, the circuitry sets the predetermined blowing condition based on a duct structure to guide an airflow generated from the airflow generator to each of the multiple wavelength converters.

The laser light sources 1a and 1b irradiate the wavelength converters 2a and 2b with the excitation light beams (i.e., the laser light beam), and the wavelength converters 2a and 2b generate heat. However, the wavelength converters 2a and 2b are cooled by blowing from the airflow generator 3. The blowing from the airflow generator 3 is divided into multiple portions in multiple directions by the structural part 6 of the duct structure 4, and the multiple portions collide with the wavelength converters 2a and 2b. Since the structural part 6 divides the cooling wind into the multiple portions in the multiple directions, the wavelength converters 2a and 2b can be cooled by one airflow generator 3.

FIG. 3B is a diagram illustrating a specific configuration of the projector light source unit according to an embodiment of the present disclosure. In an embodiment of the present disclosure, the airflows from two airflow generators 3a and 3b (e.g., sirocco fans or axial fans) are guided to the wavelength converters 2a and 2b by the duct structure 4, and the wavelength converters 2a and 2b are cooled. In other words, the blowing condition may be determined by the duct structure 4 that guides the airflow generated from the airflow generator 3a or 3b to each of the wavelength converters 2a and 2b. At this time, the blowing condition is determined based on each size of the wavelength converters 2a and 2b and each laser output to the wavelength converters 2a and 2b. The blowing condition includes the airflow volume, the wind velocity, or both, and depends on the performance or rotation speed of the sirocco fan or the axial flow fan. In the case where the sizes of the wavelength converters 2a and 2b are same, and the intensities of the laser output to the wavelength converters 2a and 2b are the same, the blowing condition to the wavelength converter 2a and the wavelength converter 2b may be one to one (1:1).

In some embodiments, in the light source device, the circuitry changes the predetermined blowing condition based on an output of the laser light beam from the laser light source to each of the multiple wavelength converters from the laser light source.

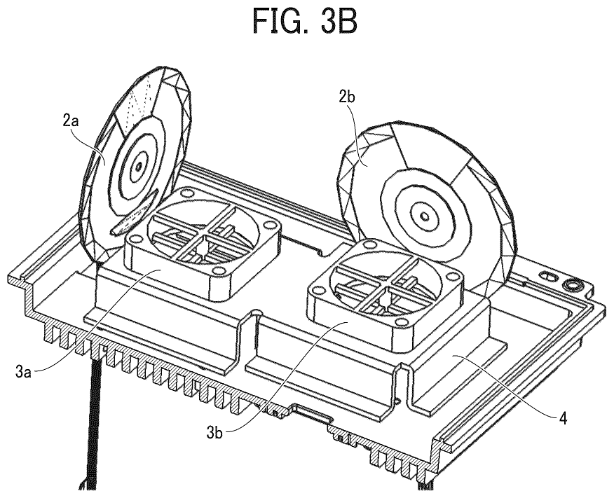

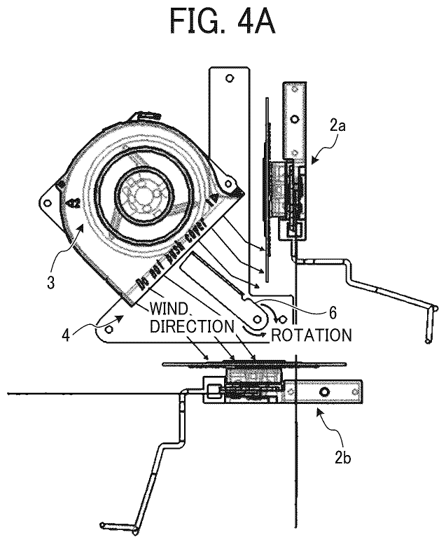

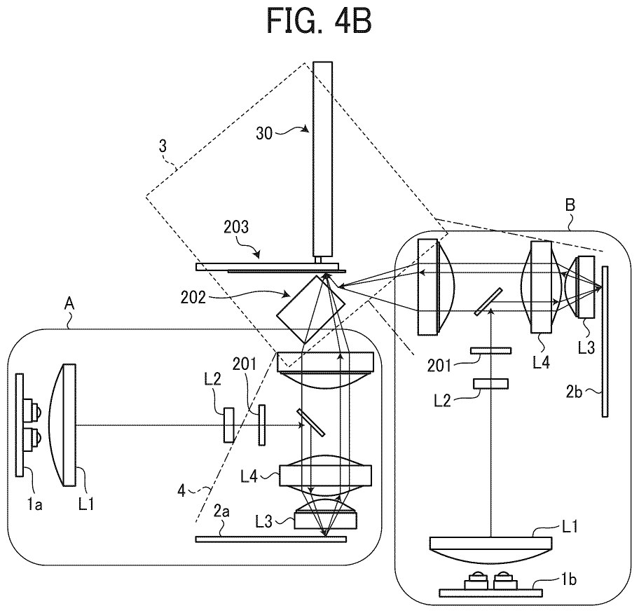

FIG. 4A is a diagram illustrating another specific configuration of the projector light source unit according to an embodiment of the present disclosure. In an embodiment of the present disclosure, a sirocco fan or an axial flow fan may be used as the airflow generator 3. The wavelength convertors 2a and 2b may be phosphor wheels. The structural part 6 of the duct structure 4 divides the airflow generated from the airflow generator 3 into two portions in two directions.

FIG. 4B is a diagram illustrating a configuration of an airflow generator and a duct structure in the case where light source modules of the light source device according to an embodiment of the present disclosure are arranged at an right-angle relation. The airflow generator 3 (e.g., a sirocco fan or an axial flow fan) is disposed over or under the wavelength-conversion light source A, the wavelength-conversion light source B, the color wheel, and the light tunnel (i.e., light homogenizer 30) so as to spread across the wavelength-conversion light source A, the wavelength-conversion light source B, the color wheel, and the light tunnel (i.e., light homogenizer 30). The duct structure 4 is disposed at a position to which the airflow from the airflow generator 3 is blown. The duct structure 4 can blow the airflow to the phosphor wheels of the wavelength converters 2a and 2b. The airflow from the airflow generator 3 may cool the whole optical components of the wavelength-conversion light source A by the duct structure 4a and the whole optical components of the wavelength-conversion light source B by the duct structure 4b in addition to the wavelength converters. For example, the airflow generator 3 and the duct structure 4 may be disposed above or below some lenses (e.g., the fly-eye lens 201), the dichroic mirror, the prism 202, the color wheel, and the light tunnel (light homogenizer 30). The airflow generator 3, the duct structure 4, and the phosphor (wavelength converters 2a and 2b) may be disposed at substantially the same height or at positions overlapping in the height direction. As a result, a space inside the light source device can be reduced.

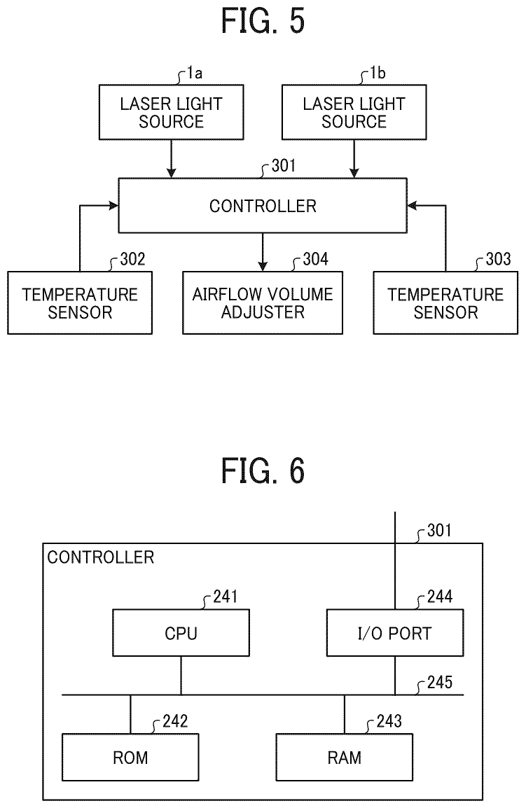

FIG. 5 is a diagram illustrating a control block of the light source device according to an embodiment of the present disclosure. As illustrated in FIG. 5, the light source device 20 according to an embodiment of the present disclosure includes a controller 301, a temperature sensor 302, a temperature sensor 303, and an airflow volume adjuster 304 in the duct structure.

The airflow volume adjuster 304 in the duct structure is a control board for the actuator or the airflow generator, and controls either or both of the mounting angle of the structural part 6 and the number of rotation of each of multiple airflow generators 3 to adjust the blowing condition to the respective wavelength converters 2a and 2b. In other words, the blowing conditions may be set to control and drive the airflow generators 3 corresponding to the wavelength converters 2a and 2b, respectively. In this case, the airflow volume adjuster 304 in the duct structure may serve as a blowing condition changer to separately determine any blowing conditions of airflow volume to be blown to the wavelength converters 2a and 2b. The temperature sensor 302 is a temperature sensor that is attached to the wavelength converter 2a and detects the temperature of the wavelength converter 2a. The temperature sensor 303 is a temperature sensor that is attached to the wavelength converter 2b and detects the temperature of the wavelength converter 2b. In other words, the temperature sensors 302 and 303 serve as a temperature sensor that detects the temperature of the wavelength converters 2a and 2b, respectively.

In some embodiments, the light source device further includes multiple airflow generators including the airflow generator. The circuitry sets the predetermined blowing condition for each of the multiple wavelength converters to control and drive the multiple airflow generators, respectively.

In some embodiments, the light source device further includes circuitry to change the blowing condition to blow an airflow to each of the multiple wavelength converters.

The controller 301 serves as circuitry that controls the airflow volume adjuster 304 in the duct structure based on the temperature detection results of the temperature sensors 302 and 303, and controls the blowing conditions to the wavelength converters 2a and 2b by the structure unit 6. As a result, the cooling airflow volumes to the wavelength converters 2a and 2b can be controlled depending on the temperatures of the wavelength converters 2a and 2b, respectively.

Specifically, when the temperature sensor 302 or the temperature sensor 303 detects a temperature exceeding a predetermined temperature, the controller 301 increases the ratio of the airflow volume to be blown to one of the wavelength converters 2a and 2b that has detected the temperature higher than the predetermined temperature to the other of the wavelength converters 2a and 2b, or increases the number of rotation of the specified airflow generator. The predetermined temperature may include the rated temperature of the wavelength converters 2a and 2b. As a result, the temperatures of the wavelength converter 2a and 2b can be prevented from exceeding the rated temperature. When the temperature sensor 302 or the temperature sensor 303 detects a temperature exceeding the predetermined temperature, the controller 301 changes the blowing condition to the wavelength converter that has detected the temperature higher than the predetermined temperature so that the cooling performance increases.

In some embodiments, in the light source device, each of the multiple wavelength converters includes a temperature sensor to detect temperature, and the circuitry changes the blowing condition based on the temperature detected by the temperature sensor.

In some embodiments, in the light source device, in response to a detection of a temperature higher than a predetermined temperature in a wavelength converter among the multiple wavelength converters by the temperature sensor. The circuitry changes the predetermined blowing condition to increase a cooling performance of the wavelength converter.

The controller 301 can also control the airflow volume adjuster 304 in the duct structure depending on the output of the excitation light beam emitted from each of the laser light sources 1a and 1b to control the blowing condition of the cooling air to the corresponding one of the wavelength convertors 2a and 2b. In the case where the temperatures of the wavelength converters 2a and 2b change depending on the outputs of the laser light sources 1a and 1b, respectively, the controller 301 adjusts the blowing conditions of the wavelength converters 2a and 2b depending on the temperature change. In other words, efficient cooling can be achieved depending on the output of the excitation light beam emitted to the wavelength converters 2a and 2b.

FIG. 6 is a diagram illustrating a hardware configuration of the controller 301 of the light source device according to an embodiment of the present disclosure. As illustrated in FIG. 6, the controller 301 includes a central processing unit (CPU) 241, a read-only memory (ROM) 242, a random-access memory (RAM) 243, an input/output (I/O) port 244, and a bus line 245.

The CPU 241 is an arithmetic device that executes sequential processing, branch processing, and iterative processing by executing a program stored in the ROM 242. The ROM 242 is a nonvolatile storage device that stores, for example, the program executed by the CPU 241. The RAM 243 is a memory that functions as a work area for the operation of the CPU 241. The bus line 245 is an address bus or a data bus to electrically connect components such as the CPU 241.

The I/O port 244 is an interface into which an output signal of the rotary encoder is input and that outputs a control signal that controls a motor via a motor driver. Among the functions of the embodiment described above, the function executed by the controller 301 can be achieved by one or more processing circuits. The controller 301 according to an embodiment of the present disclosure includes a processor programmed to perform each function by software such as a processor implemented by an electronic circuit, and a device such as an application-specific integrated circuit (ASIC), a digital signal processor (DSP), a field-programmable gate array (FPGA), or a typical circuit module designed to perform each function described above.

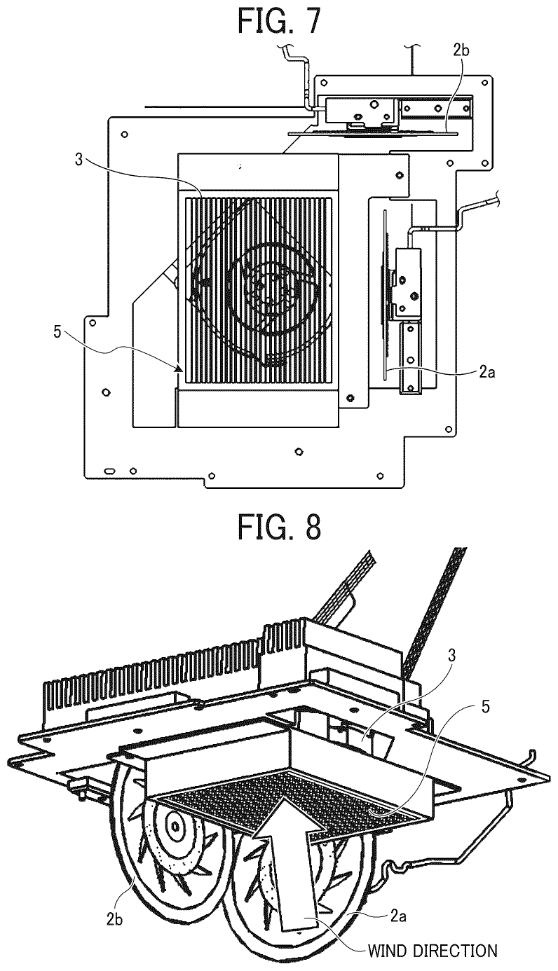

FIG. 7 is diagram illustrating a heat dissipation part of the light source device according to an embodiment of the present disclosure. In an embodiment of the present disclosure, as illustrated in FIGS. 7 and 8, the light source device 20 includes a fin structure 5 (serving as a heat dissipation part) thermally connected to the outside of the projector light source unit in front of an air intake port of the airflow generator 3 (e.g., a sirocco fan) to blow cooling air. The fin structure 5 is disposed on the air intake path of the airflow generator 3 and thermally connected to the outside of the light source device 20. The fin structure 5 serves as a heat dissipating part. As a result, since the heat of the air in the light source device 20 can be released to the outside when the air is taken into the duct structure 4, the wavelength converters 2a and 2b (e.g., phosphor wheels) can be cooled by using cooling air having lower temperature. In other words, the temperature of the air supplied to the wavelength converters 2a and 2b can be decreased.

In some embodiments, the light source device further includes a heat dissipation part thermally connected to an exterior of the light source device. The heat dissipation part is on an intake air path of the airflow generator.

In some embodiments, in the light source device, a portion of the duct structure has a fin-shape to dissipate heat.

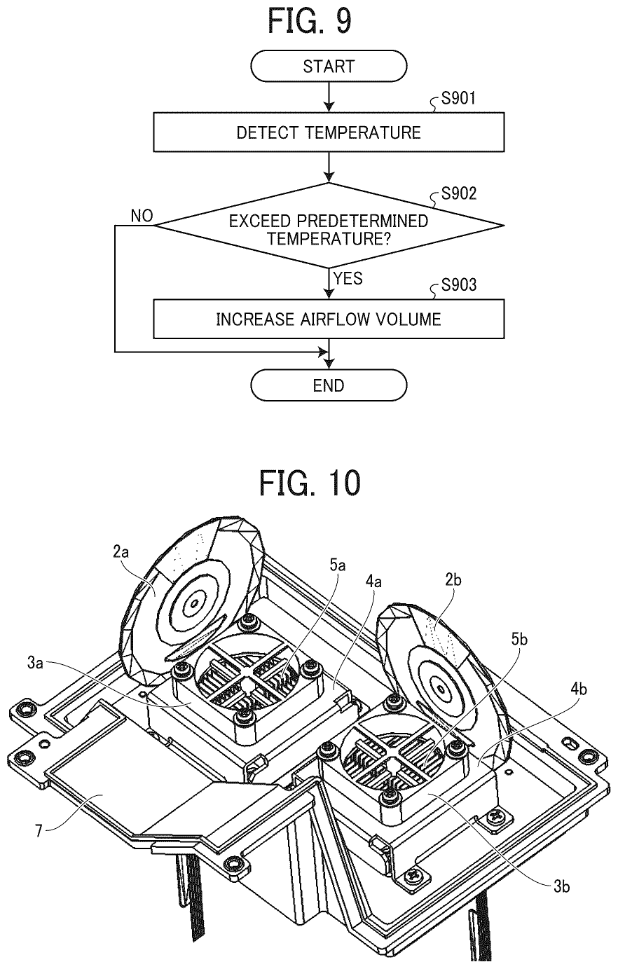

FIG. 9 is a flowchart of a control process of an airflow condition by a light source device according to an embodiment of the present disclosure. The temperature sensors 302 and 303 detect the temperatures of the wavelength converters 2a and 2b (step S901). The controller 301 determines whether the temperature detected by the temperature sensor 302 or the temperature sensor 303 exceeds a predetermined temperature (step S902).

When the temperature sensor 302 or the temperature sensor 303 detects a temperature exceeding a predetermined temperature (step S902: YES), the controller 301 increases the ratio of the airflow volume to be blown to one of the wavelength converters that has detected temperature higher than the predetermined temperature to the other of the wavelength converters (step S903). In the case where the temperature sensor 302 and the temperature sensor 303 detect the temperature of the predetermined temperature or less (step S902: No), the controller 301 ends the control process of the blowing condition.

FIG. 10 is a diagram illustrating the duct structure having a characteristic structure of a light source device according to an embodiment of the present disclosure. In an embodiment of the present disclosure, the light source device 20 includes the airflow generator 3a and the airflow generator 3b (e.g., an axial fan), and intakes or exhausts air through the duct structure 4a and the duct structure 4b, and the wavelength converter 2a and the wavelength converter 2b are cooled. The airflows taken in or exhausted from the airflow generators 3a and 3b pass through the fin structures 5a and 5b in the duct structure 4, so that the heat can be dissipated to the duct structures 4a and 4b, and the wavelength converters 2a and 2b can be cooled using the cooling having lower temperature, or the internal temperature of the whole device of the light source device 20 can be decreased. In other word, the duct structures 4a and 4b may have fin structures 5a and 5b in a part of the duct structures 4a and 4b to dissipate heat.

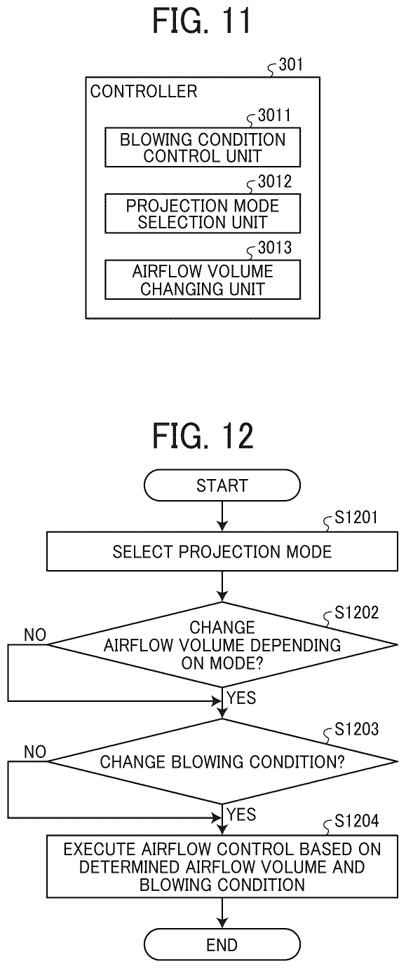

FIG. 11 is a diagram illustrating a functional configuration of a controller in a light source device according to an embodiment of the present disclosure. In an embodiment of the present disclosure, the controller 301 may include a blowing condition control unit 3011, a projection mode selection unit 3012, and an airflow volume changing unit 3013.

When the temperature sensor 302 or the temperature sensor 303 detects temperature exceeding a predetermined temperature, the blowing condition control unit 3011 increases the ratio of the airflow volume to be blown to one of the wavelength converters that has detected the temperature higher than the predetermined temperature to the other of the wavelength converters, or increases the number of rotation of a specified airflow generator.

The projection mode selection unit 3012 receives a projection mode selected by the user. The projector apparatus according to an embodiment of the present disclosure is used in business use (e.g. a projection display for a meeting or a presentation), home use, medical user (e.g., an monochromatic (grayscale) image for an X-ray imaging or a magnetic resonance imaging (MRI)), public use (e.g., a projection display to display various kinds of information, an advertisement, and a signage in public places, stores, or a transportation facility), or industrial use (e.g., a projector apparatus installed in a factory).

Further, the projector apparatus according to an embodiment of the present disclosure has a projection mode depending on applications. Examples of the projection mode include a color mode, a moving image mode, an image mode, a mode for a medical image (Digital Imaging and Communications in Medicine (DICOM) mode) to project a medical image, and a public mode to project guidance and signage out of doors or in a store. The control of the driving method and the driving amount of the light source, the electric power, the cooling, and the output can be automatically changed depending on the change of the projection mode.

In some embodiments, in the light source device further includes: a projection mode selector to accept a selected projection mode; and the circuitry changes: an airflow generated by the airflow generator based on the selected projection mode; and the blowing condition based on the temperature detected by the temperature sensor in response to a change in the selected projection mode.

The airflow volume changing unit 3013 changes the airflow volume (the whole air volume) of the airflow generated from the airflow generator 3 depending on the selected projection mode. The blowing condition control unit 3011 (serving as a blowing condition changer) changes the airflow condition depending on the detected results of the temperature sensors 302 and 303 when the projection mode is changed. As a result, an airflow having an airflow volume suitable for the projection mode or an environment (e.g., the detected result) to the wavelength converter 2a and the wavelength converter 2b.

FIG. 12 is a flowchart of a condition change process of the airflow volume or the blowing condition depending on the projection mode in the light source device according to one embodiment of the present disclosure. Examples of the projection mode include a color mode, a moving image mode, an image mode, a mode for a medical image to project a medical image, and a public mode to project guidance and signage out of doors or in a store.

The projection mode selection unit 3012 receives a selection of the projection mode selected by a user through an operation (step S1201). Since the amount of heat generation of the light source module changes depending on the selected projection mode, the airflow volume changing unit 3013 determines whether to change the air volume required for cooling (step S1202: Yes or No). The airflow volume changing unit 3013 may determine whether the airflow volume (whole air volume) of the fan in the airflow generator 3 is changed. For example, the airflow volume changing unit 3013 may change the airflow volume (i.e., amount of fan driving) to be larger in the following order of the projection mode: the color mode<the image mode<the moving image mode<the medical mode<the projection mode such as public mode.

The airflow volume changing unit 3013 determines whether to change the blowing conditions for each wavelength converter based on various information or various conditions (such as the temperature detected by each temperature sensor of each wavelength converter) at that time (step S1203: Yes or No). The airflow volume changing unit 3013 executes the airflow control of the airflow from the airflow generator 3 under the changed airflow volume (whole air volume) and the blowing condition (step S1204). Accordingly, the airflow volume that matches the projection mode and the state of the projection mode to each wavelength converter can be blown.

As described above, in the light source device 20 according to an embodiment of the present disclosure, the airflow generated from the single airflow generator 3 can be divided into two or more portions to cool the wavelength converters 2a and 2b depending on the temperature conditions of the wavelength converters 2a and 2b. As a result, in the projector optical unit including multiple wavelength converters 2a and 2b, the cooling optimized for the temperature state of each of the wavelength converters 2a and 2b can be achieved while preventing the size of the projector optical unit from increasing.

Aspects of the present disclosure are as follows.

### First Aspect

A light source device includes: a laser light source to emit a laser light beam having a wavelength; multiple wavelength converters to convert the wavelength of the laser light beam emitted from the laser light source to other wavelengths different from the wavelength to emit other light beams having the other wavelengths; an airflow generator to generate at least one airflow; and a blower to blow said at least one airflow to each of the multiple wavelength converters based on a predetermined blowing condition.

### Second Aspect

In the light source device according to the first aspect, the predetermined blowing condition is set for each of the multiple wavelength converters according to at least one of: setting information of an airflow volume of said at least one airflow; or a structure of the blower.

### Third Aspect

The light source device according to the first aspect further includes multiple airflow generators including the airflow generator. The blowing condition is set to control and drive the multiple airflow generators corresponding to the multiple wavelength converters, respectively.

### Fourth Aspect

In the light source device according to the first aspect, the blowing condition is determined by a duct structure to guide an airflow generated from the airflow generator to each of the multiple wavelength converters.

### Fifth Aspect

The light source device according to any one of the first to fourth aspects further includes a changer to change the blowing condition to blow an airflow to each of the multiple wavelength converters.

### Sixth Aspect

In a sixth aspect, in the light source device according to the fifth aspect, each of the multiple wavelength converters includes a temperature sensor to detect temperature. The light source device includes a controller to control the changer based on the temperature detected by the temperature sensor to change the blowing condition.

### Seventh Aspect

In the light source device according to the sixth aspect, in the case where the temperature sensor detects a higher temperature than a predetermined temperature in a wavelength converter among the multiple wavelength converters, the controller changes a blowing condition for the wavelength converter having the higher temperature detected by the temperature sensor, to increase a cooling performance for the wavelength converter having the higher temperature.

### Eighth Aspect

The light source device according to any one of the fifth aspect includes a controller to control the changer based on an output of a laser light beam to each of the multiple wavelength converters from the laser light source to change the blowing condition.

### Ninth Aspect

The light source device according to any one of the first to eighth aspects includes a heat dissipation part thermally connected to an outside of the light source device and disposed on an intake air path of the airflow generator.

### Tenth Aspect

In the light source device according to any one of the fourth to ninth aspects, a portion of the duct structure has a fin-shape to dissipate heat.

### Eleventh Aspect

The light source device according to the sixth aspect further includes: a projection mode selection unit to accept a selected projection mode; and an airflow changer to change an airflow volume of an airflow generated by the airflow generator, based on the selected projection mode. The changer changes the blowing condition based on the temperature detected by the temperature sensor in response to a change in the selected projection mode.

### Twelfth Aspect

A projector apparatus includes: a projection optical system to project an image formed by an image forming element with a light beam from the light source device according to any one of the first to eleventh aspects.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above. Each of the functions of the described embodiments may be implemented by one or more processing circuits or circuitry. Processing circuitry includes a programmed processor, as a processor includes circuitry. A processing circuit also includes devices such as an application specific integrated circuit (ASIC), a digital signal processor (DSP), a field programmable gate array (FPGA), and conventional circuit components arranged to perform the recited functions.

1. A light source device comprising:
a laser light source to emit a laser light beam having a wavelength;
multiple wavelength converters to convert the wavelength of the laser light beam emitted from the laser light source to other wavelengths different from the wavelength to emit other light beams having the other wavelengths;
an airflow generator to generate at least one airflow; and
a blower to blow said at least one airflow to each of the multiple wavelength converters based on a predetermined blowing condition.

2. The light source device according to claim 1, further comprising circuitry configured to set the predetermined blowing condition for each of the multiple wavelength converters according to at least one of:
setting information of an airflow volume of said at least one airflow; or
a structure of the blower.

3. The light source device according to claim 2, further comprising multiple airflow generators including the airflow generator,
wherein the circuitry is configured to set the predetermined blowing condition for each of the multiple wavelength converters to control and drive the multiple airflow generators, respectively.

4. The light source device according to claim 1,
wherein the circuitry is configured to set the predetermined blowing condition based on a duct structure to guide an airflow generated from the airflow generator to each of the multiple wavelength converters.

5. The light source device according to claim 1, further comprising circuitry to change the predetermined blowing condition to blow an airflow to each of the multiple wavelength converters.

6. The light source device according to claim 5,
wherein each of the multiple wavelength converters includes a temperature sensor to detect temperature,
the circuitry changes the predetermined blowing condition based on the temperature detected by the temperature sensor.

7. The light source device according to claim 6,
in response to a detection of a temperature higher than a predetermined temperature in a wavelength converter among the multiple wavelength converters by the temperature sensor,
wherein the circuitry changes the predetermined blowing condition to increase a cooling performance of the wavelength converter.

8. The light source device according to claim 5,
wherein the circuitry changes the predetermined blowing condition based on an output of the laser light beam from the laser light source to each of the multiple wavelength converters.

9. The light source device according to claim 1, further comprising a heat dissipation part thermally connected to an exterior of the light source device,
wherein the heat dissipation part is on an intake air path of the airflow generator.

10. The light source device according to claim 4, wherein a portion of the duct structure has a fin-shape to dissipate heat.

11. The light source device according to claim 6, further comprising:
a projection mode selector to accept a selected projection mode; and
the circuitry changes:
an airflow generated by the airflow generator based on the selected projection mode; and
the predetermined blowing condition based on the temperature detected by the temperature sensor in response to a change in the selected projection mode.

12. A projector apparatus comprising:
a projection optical system to project an image formed by an image forming element with the light beam from the light source device according to claim 1.
